(19) United States
(12) Patent Application Publication
(10) Pub. No.: US 2010/0125548 A1
(43) Pub. Date: May 20, 2010

(54) SUPPORT INFORMATION PROVIDING SYSTEM, SUPPORT INFORMATION PROVIDING METHOD, AND SUPPORT INFORMATION PROVIDING PROGRAM

(76) Inventors: Takeshi ANZAI, Yokohama (JP); Masataka Kan, Yokohama (JP); Masaru Iwashita, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/507,310

(22) Filed: Jul. 22, 2009

(30) Foreign Application Priority Data
Nov. 14, 2008 (JP) 2008-291845

(51) Int. Cl. G06F 9/46; G06F 17/30

(52) U.S. Cl. 707/608; 718/100; 707/E17.009; 707/E17.014; 707/758

(57) ABSTRACT

A support information providing apparatus narrows, when one task item belonging to one task step is to be executed, a plurality of support information candidates down to one support information candidate related to one task item to be executed, in accordance with a task status of a task item by a worker belonging to a task step ordered before one task step of one task item; and provides the narrowed-down support information candidate being related to the task item to be executed.

### INCORPORATION BY REFERENCE

The present application claims priority from Japanese application JP 2008-291845 filed on Nov. 14, 2008, the content of which is hereby incorporated by reference into this application.

### BACKGROUND OF THE INVENTION

The present invention relates to support information providing system, a support information providing method, and a support information providing program.

A navigation system is known providing a worker with work support information while the worker executes a job by utilizing an IT system. The navigation system provides an task procedure necessary for a worker to execute a job, and support information such as a task manual and FAQ. In this case, it is required to provide support information necessary for a worker in each task status.

Techniques in JP-A-9-245042 (Paragraph [0006]) provide support information by utilizing history information on tasks of a worker.

According to the techniques in JP-A-9-245042 (Paragraph [0006]), a probability of support information necessity is calculated from a tendency of task history of a worker to decide support information to be displayed.

Techniques in JP-A-8-44520 (Paragraph [0007], FIGS. 7 and 8) and JP-A-10-111778 (Paragraph [0009], FIGS. 3 and 4) judge a skill of a worker from an task time taken by the worker, and decide support information to be displayed, basing upon the skill.

However, the techniques in JP-A-9-245042 (Paragraph [0006]) do not consider information such as a task time and input information, and cannot display narrowed-down effective support information if there are a variety of task statuses.

The techniques in JP-A-8-44520 (Paragraph [0007], FIGS. 7 and 8) and JP-A-10-111778 (Paragraph [0009], FIGS. 3 and 4) provide support information simply in accordance with a lapse time taken by a currently executing task, and do not consider that the worker was not skilled in what task executed before the currently executing task. It is therefore not possible to provide support information corresponding to the contents of a task currently executed by a worker.

### SUMMARY OF THE INVENTION

It is therefore an object of the present invention to provide support information judged necessary for executing a current task step in accordance with a task status of a previous task step, for each task item of the current task step.

The support information providing system of the present invention narrows, when one task item belonging to one task step is to be executed, a plurality of support information candidates down to one support information candidate related to one task item to be executed, in accordance with a task status of a task item by a worker belonging to a task step ordered before one task step of one task item; and provides the narrowed-down support information candidate being related to the task item to be executed.

According to the present invention, it is possible to provide support information judged necessary for executing a current task step in accordance with a task status of a previous task step, for each task item of the current task step.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram illustrating the whole configuration of a present embodiment.

FIG. 2A is a diagram illustrating an example of a task activity management database of the present embodiment.

FIG. 2B is a diagram illustrating an example of a task time management database of the present embodiment.

FIG. 2C is a diagram illustrating an example of a task item relation management database of the present embodiment.

FIG. 3 is a diagram illustrating an example of a support information definition database according to the present embodiment.

FIG. 4 is a diagram illustrating an example of a view information definition database according to the present embodiment.

FIGS. 5A and 5B are diagrams illustrating examples of a navigation view according to the present embodiment.

FIG. 6 is a flow chart illustrating a support information display process sequence according to the present embodiment.

FIG. 7 is a flow chart illustrating a support information display process sequence using a first judgment method according to the present embodiment.

FIG. 8 is a flow chart illustrating a support information display process sequence using a second judgment method according to the present embodiment.

FIG. 9 is a flow chart illustrating a view forming process sequence according to the present embodiment.

### DESCRIPTION OF THE EMBODIMENTS

With reference to the accompanying drawings and the like, detailed description will now be made on best modes (called “embodiments”) for carrying out the present invention.

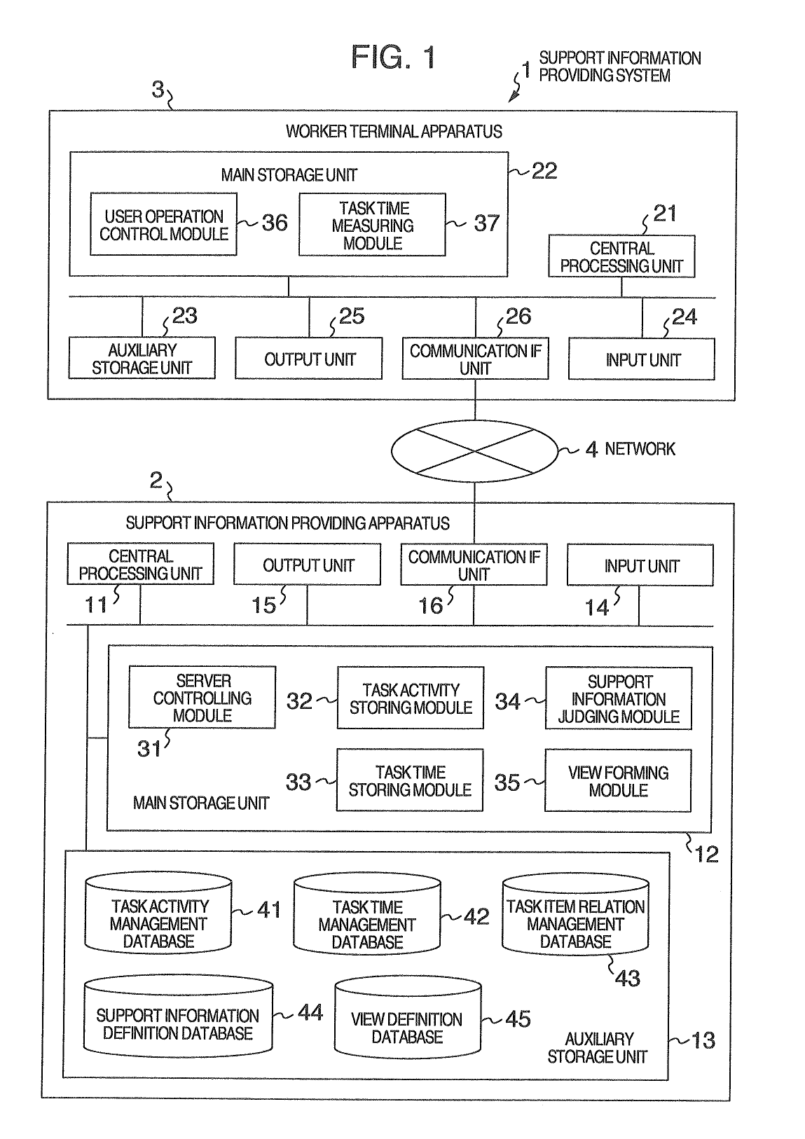

FIG. 1 is a diagram illustrating the whole configuration of an embodiment.

A support information providing system 1 has a support information providing apparatus 2 and a worker terminal apparatus 3 interconnected by a network 4.

The support information providing apparatus 2 is a general computer having a central processing unit 11, a main storage unit 12, an auxiliary storage unit 13, an input unit 14, an output unit 15 and a communication interface (IF) unit 16. These units are interconnected by a bus.

The auxiliary storage unit 13 stores a task activity management database 41, a task time management database 42, a task item relation management database 43, a support information definition database 44, and a view information definition database 45.

A server control module 31, a task activity storing module 32, a task time storing module 33, a support information judging module 34, and a view forming module 35 are all programs. In the following, a sentence describing a subject, e.g., “the ◯◯ module operates to”, means that the central processing unit 11 reads the program from the auxiliary storage unit 13 and loads it in the main storage unit 12 to realize the function of the program. In FIG. 1, although a single support information providing apparatus 2 is drawn, the programs and databases may be distributively provided in a plurality of housings.

The worker terminal apparatus 3 is a general computer to be used by a worker.

The worker terminal apparatus 3 has a central processing unit 21, a main storage unit 22, an auxiliary storage unit 23, an input unit 24, an output unit 25 and a communication interface (IF) unit 26. These units are interconnected by a bus. The worker terminal apparatus 3 stores therein a network browser although not shown. There are one or more worker terminal apparatus 3.

### (Terms)

A job to be executed by a worker will be described by dividing the job into a “task step” and a “task item”.

The “task step” is each of a plurality of processes dissolved from a job to be executed by a worker and sequentially ordered.

The “task item” is each of a plurality of viewpoints or aspects (i.e., items) dissolved from one task step. It can be said that the task step is higher hierarchical concept, whereas the task item is lower hierarchical concept.

Although there is an order among task steps, there is no particular order among task items of each task step.

Examples of the task step may be first “acquisition of customer needs (A)”, second “decision of services to be provided (B)”, and third “presentation (C)”.

Examples of the task item may be “confirmation of customer budget (A1)”, “issue arrangement (A2)”, and “confirmation of delivery date (A3)” for the task step of “acquisition of customer needs (A), “decision of already existing applications (B1) and “development of new applications (B2) for the task step of “decision of services to be provided (B)”, and “explanation of estimate basis (C1)” and “explanation of schedule (C2) for the task step of “presentation (C)”. In this case, although two or three task items are given for each task step, the number of task items is not limited thereto.

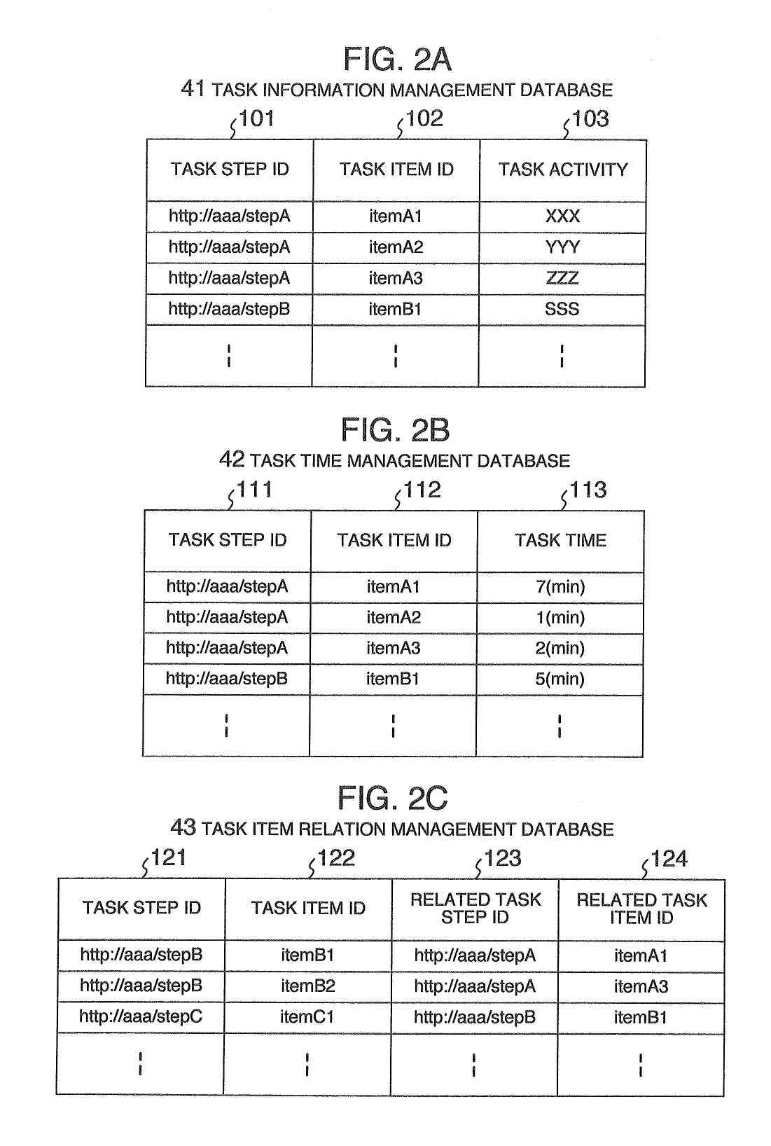

The above-described task step such as “A” corresponds to a task step ID such as “http://aaa/stepA” in FIG. 2A or the like to be described later, and the above-described task item such as “A1” corresponds to a task item ID such as “itemA1” in FIG. 2A or the like.

If a task item belonging to a task step is related to a task item belonging to a succeeding task step (assuming that the former task item becomes the requisite for the succeeding task item requiring similar task knowledge and know how), the former task item is defined as a “related task item” of the latter task item. For example, if the task item “confirmation of customer budget (A1) is related to the task item “decision of already existing applications (B1)”, the task item “confirmation of customer budget (A1) is a related task item of the task item “decision of already existing applications (B1)”. The task item and related task item are not necessarily required to be one-to-one correspondence. However, in this embodiment, it is assumed for the purposes of simplicity that one task item is related to one related task item (the details will be described in FIG. 2C). The task item A2 does not become a related task item of any task item. Further, it is assumed for the purposes of simplicity that a relation between a related task item and a task item is a relation between a task item belonging to a task step and a task item belonging to the immediately succeeding task step. However, this is only illustrative, and a task item belonging to one task step may be a related task item of a task item belonging to a task step at some steps after the first-mentioned task step.

In this embodiment, although the relation between task items is defined in the manner described above, the relation between task steps is not specifically defined excepting the ordering thereof.

A “current task step” is a task step presently executed by a worker.

A “previous task step” is a task step before the current task step. In this embodiment, although the immediately preceding task step is used as the “previous task step for the purposes of simplicity, the embodiment is not limited thereto.

“Support information” is support information helpful for executing a task item of the current task step.

A “task status” is data capable of being acquired from a worker such as a task time, input data, and mouse task results. The “task status” is used when support information to be displayed is judged.

A “task activity” is information other than the task time of the task status. Namely, the task activity includes the input data and mouse task results which are all data capable of being acquired from a worker.

The “task time” is a lapse time from the start to end of executing a task item. Although a number of jobs may exist each being constituted of a plurality of ordered “task steps”, this will not be described in detail because this is not directly relevant to the contents of the present invention.

### (Task Information Management Database)

FIG. 2A is a diagram illustrating an example of a task activity management database of the embodiment. In the task activity management database 41, task item IDs and task activities are stored in a task item ID column 102 and a task activity column 103, respectively, relative to task step IDs stored in a task ID column 101.

The task step ID in the task step ID column 101 is an identifier for uniquely identifying each task step. In this case, a URL is used as the task step ID.

The task item ID in the task item ID column 102 is an identifier for uniquely identifying a task item.

The task activity in the task activity column 103 is information other than the task time of the task status as described previously. Input data may be a character string as well as a video file, an audio file and the like or information representative of the locations thereof.

The task activity management database 41 has records corresponding in number to the number of combinations of the task step ID and task item ID.

### (Task Time Management Database)

FIG. 2B is a diagram illustrating an example of a task time management database.

In the task time management database 42, task step IDs, task item IDs and task times are stored in a task step ID column 111, a task item ID column 112 and a task time column 113, respectively.

The task step ID in the task step ID column 111 is the same as the task step ID in FIG. 2A.

The task item ID in the task item ID column 112 is the same as the task item ID in FIG. 2A.

A task time in the task time column 113 is a lapse time from the start to end of executing a task item as described previously.

The task time management database 42 has records corresponding in number to the number of combinations of the task step ID and task item ID.

A “task status management database” corresponds to both the “task activity management database” and “task time management database”.

### (Task Item Relation Management Database)

FIG. 2C is a diagram illustrating an example of a task item relation management database.

In the task item relation management database 43, task item IDs, related task step IDs and related task item IDs are stored in a task item ID column 122, a related task step ID column 123 and a related task item ID column 124, respectively, relative to task step IDs stored in a task step ID column 121.

The task step ID in the task step ID column 121 is a task step ID for uniquely identifying each task step to which the corresponding task item belongs, and the same as the task step ID in FIG. 2A.

The task item ID in the task item ID column 122 is the same as the task item ID in FIG. 2A.

The related task step ID in the related task step ID column 123 is a task step ID for identifying the task step to which the related task item belongs, and the same as the task step ID in FIG. 2A.

The related task item ID in the related task item column 124 is a task item ID for identifying a related task item related to the task item, and the same as the task item ID in FIG. 2A.

In the task item relation management database 43, the task item and related task item are directly related. In FIG. 2C, for example, “itemA1” is a related task item of “itemB1”. As described previously, it is defined that a related task item of a task item belonging to a task step is a task item belonging to a task step immediately before the first-mentioned task step. Therefore, a task item belonging to the first task step is not stored in the task item column 122. Similarly, a task item belonging to the last task step is not stored in the related task item ID column 124.

A “first identifier” and a “second identifier” correspond to the task item ID and related task item ID, respectively.

The task item relation management database 43 can be set as desired by a worker in advance by considering the relation between task items. In the following description, the task item relation management database 44 is considered as already set and given.

### (Support Information Definition Database)

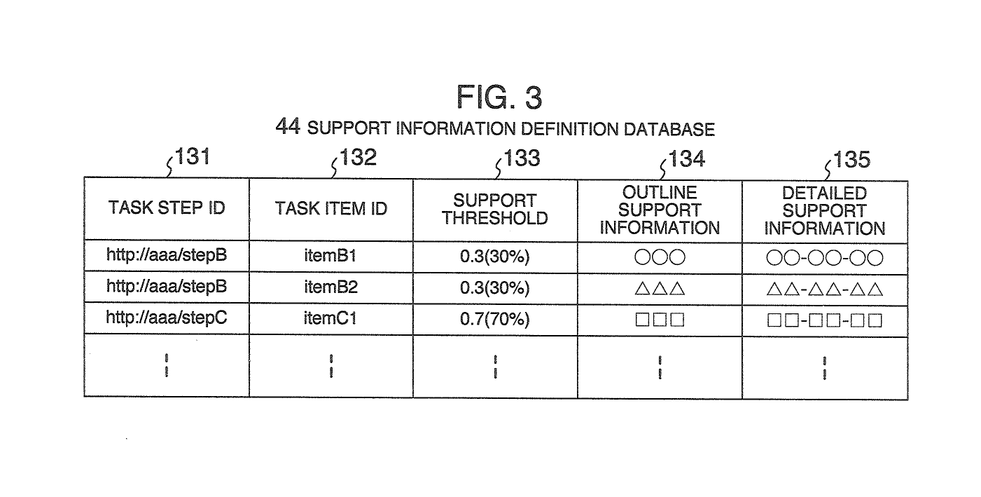

FIG. 3 is a diagram illustrating an example of a support information definition database of the embodiment.

In the support information definition database 44, task step IDs, support thresholds, outline support information and detailed support information are stored in a task item ID column 132, a support threshold column 133, an outline support information column 134 and a detailed support information column 135, respectively, relative to task step IDs stored in a task step ID column 131.

The task ID in the task step ID column 131 is the same as the task ID in FIG. 2A.

The task item ID in the task item ID column 132 is the same as the task item ID in FIG. 2A.

The support threshold in the support threshold column 133 is a reference value to be used when support information is judged in accordance with the task status at the previous task step (selecting either the outline support information or the detailed support information). In this case, the support threshold is represented by a value (percentage) obtained by dividing a task time of a task item belonging to the previous task step by a sum of task times of all task items belonging to the previous task step.

The outline support information of the outline support information column 134 is support information of any type of character information, video information, audio information and the like to be presented while a worker executes a job regarding a task item.

The detailed support information of the detailed support information column 135 is support information detailed more than the outline support information, of any type of character information, video information, audio information and the like to be presented while a worker executes a job regarding a task item.

A “granularity” corresponds to classification of the support information into “detailed” and “outline”. In this example, although the granularity of two stages is adopted for the purposes of simplicity, a granularity of multi-stages may also be adopted although the larger the number of stages, the number of support thresholds increases more.

In the following description, the contents of the outline support information and detailed support information explain a related task item. The reason for this is as follows. If a worker takes a longer time to execute a related task item, generally the worker understands insufficiently the contents of the related task item, so that it is natural to assume that support information for helping understanding is required when a corresponding task item is executed by the worker (the details thereof will be described later). However, this is only illustrative, and the contents of the outline support information and detailed support information may be set independently from the related task item.

For example, the following aspects can be understood if attention is paid to a record in the first row in FIG. 3.

(1) Outline support information “◯◯◯” and detailed support information “◯◯-◯◯-◯◯” are support information to be provided while a worker executes an task item “itemB1”.

(2) If a task time for the related task item (item A1 upon reference to FIG. 2C) of the task item “itemB1” is longer than 30% or larger of a total sum of task times for all task items of the task step including “itemA1”, the detailed support information is provided as the support information, whereas if shorter than 30%, the outline support information is provided as the support information.

Although the outline support information “◯◯◯” and detailed support information “◯◯-◯◯-◯◯” are provided while a worker executes a task item “itemB1”, the contents of the support information are preferably the contents regarding the related task item “itemA1”. Namely, since it took a long time to execute the related task item “itemA1”, the worker views (memorizes) the support information explaining the “confirmation of customer budget (A1)” while executing the task item “decision of already existing applications (B1)”. Examples of the support information may be character information (outline support information) on “Consider a yearly budget of a customer” or character information (detailed support information) on “Caution: a yearly budget of a customer is settled either on a contract basis or a payment basis”.

Support information and support thresholds of the support information definition database 44 can be set as desired by a worker in advance. In the following description, the support information definition database 44 is considered as already set and given.

### (View Definition Database)

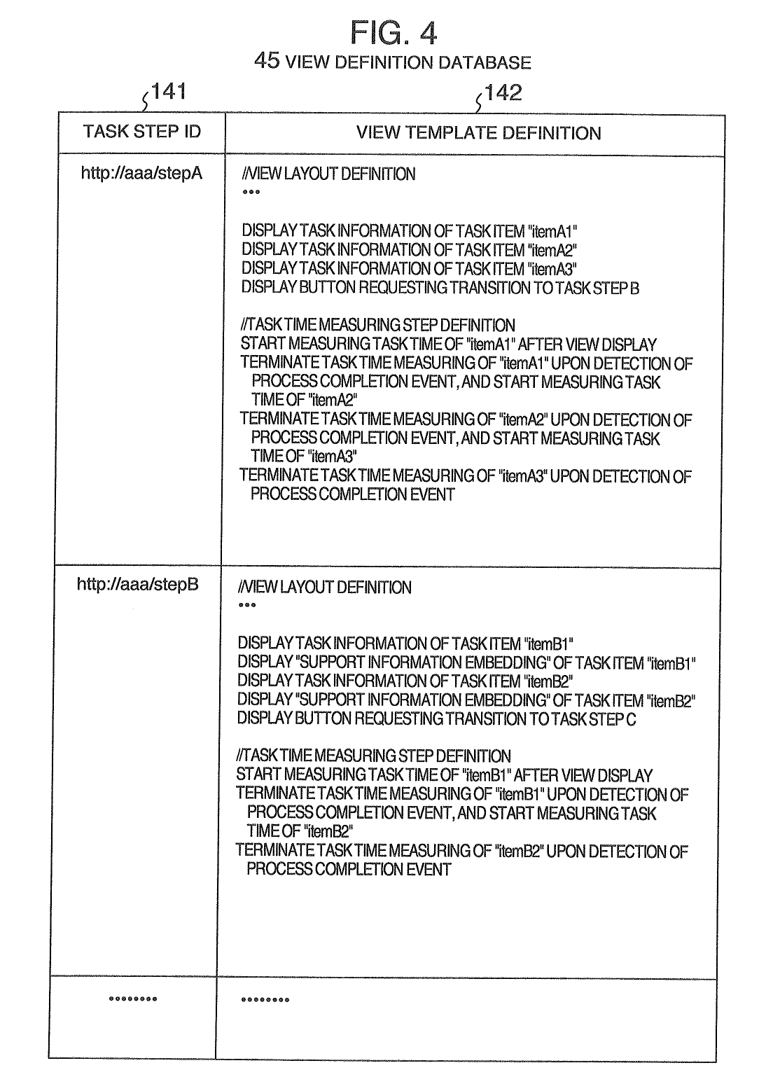

FIG. 4 is a diagram illustrating an example of a view definition database of the embodiment.

The view definition database 45 stores a view template definition in a view template definition column 142 relative to each task step ID stored in a task step ID column 141.

The task step ID in the task step ID column 141 is the same as the task step ID in FIG. 2A.

The view template definition in the view template definition column 142 is information which defines the structure of a navigation view (the details will be described later), and has a section of a view layout definition and a section of a task time measuring process definition.

The section of the view layout definition defines a view layout including display components such as a button, an input form and a pulldown to be displayed in a view, and position information and color information thereof. This information is collectively described as “task information” in FIG. 4.

The section of the task time measuring step definition defines a process logic for measuring a task time of each task item taken by a worker.

It is assumed that records are described in the order of executing task steps.

Paying attention, for example, to records of first and second rows, the following matters exist.

(1) One navigation view is displayed for the first task step “http://aaa/stepA”, and one navigation view is displayed also for each of the second and following task steps “http://aaa/stepB”, etc. (one record corresponds to one navigation view).

(2) In the navigation view of each of the second and following task steps “http://aaa/stepB”, etc., “support information” not existing in the navigation view of the first task step “http://aaa/stepA) is displayed.

(3) In the navigation view of each of the second and following task steps “http://aaa/stepB”, etc., support information is displayed for each task item, for example, “support information” for the task item “itemB1” and another piece of “support information” for the task item “itemB2”.

### (Navigation View)

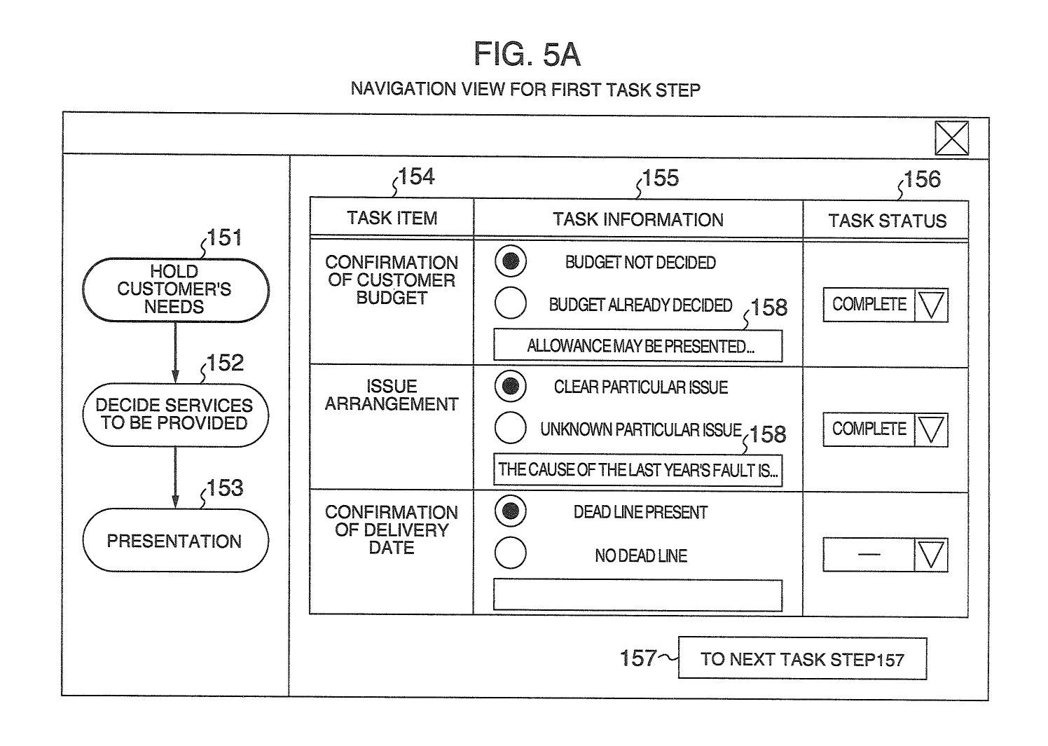

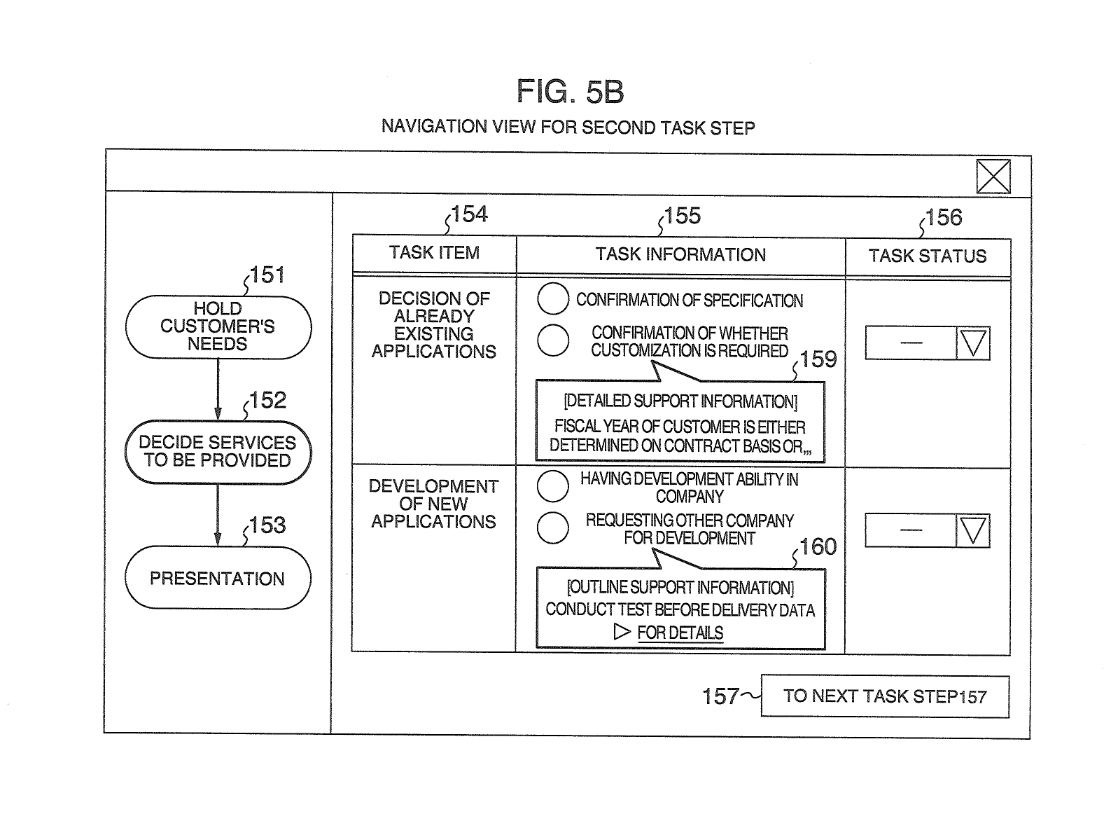

FIGS. 5A and 5B are diagrams illustrating examples of the navigation view of the embodiment.

FIG. 5A illustrates a navigation view of the first task step “http://aaa/stepA”. It is assumed that “hold customer's needs” as the name of the task step is stored being related to the task step ID, and the name is displayed in an object 151. Names of the next task step and second next task step are displayed in objects 152 and 153, respectively. Emphasized display (bold line) of the object 151 indicates that the “hold customer's needs” is a current task step.

Task information and task status are displayed in a task information column 155 and a task status column 156, respectively, being related to a task item in a task item column 154.

The task item in the task item column 154 is a task item belonging to the current task step.

The task information in the task information column 155 is information to be used by a worker executing a task, such as display components including a button, an input form and a pulldown as described previously. In this example, the radio button to be selected by a worker is used. An input form 158 may be displayed for inputting job activities.

The task status in the task status column 156 is either “-” indicating that the task item is being performed or “complete” indicating that the task item is completed, and is selected upon manipulation by a worker.

A worker first inputs job activities in the input form 158 and selects a radio button, for the task item “confirmation of customer budget”. After the task for the task item is completed, the worker selects the task status “complete”. Next, the task for the task item “issue arrangement” is executed. In this example, it is assumed that tasks are executed in the order of “confirmation of customer budget”→“issue arrangement”→“confirmation of delivery date”. However, the task order of task items is not limited thereto.

After the task status “complete” is selected for all task items, the worker depresses the button 157 “to next task step” so that the view is transited to the navigation view in FIG. 5B. If the task status “complete” is not selected for all task items, the button 157 “to next task step” may be arranged being unable to be depressed.

FIG. 5B illustrates the navigation view of the second task step “http://aaa/stepB” (a navigation view similar to this view is displayed also for the third and following task step). It is assumed that “hold customer's needs” as the name of the task step is stored being related to the task step ID, and the name is displayed in an object 152. Emphasized display (bold line) of the object 152 indicates that the “decision of customer's needs” is the current task step. At this time, the “hold customer's needs” is the previous task step.

In FIG. 5B, detailed support information 159 and outline support information 160 not displayed in FIG. 5A are displayed in the task information column 155. The detailed support information 159 corresponds to “◯◯-◯◯-◯◯” in FIG. 3.

Specifically, the worker took a task time of the support threshold or longer for the task item “confirmation of customer budget (A1)” belonging to the previous task step “hold customer's needs”, and it is preset that the “confirmation of customer budget (A1)” is a related task item of the “decision of already existing applications (B1)” (the first row in FIG. 2C). Therefore, the detailed support information 159 explaining the related task item “confirmation of customer budget (A1)” is displayed being related to the “decision of already existing applications (B1)” of the navigation view.

The outline support information 160 corresponds to “ΔΔΔ” in FIG. 3.

Specifically, the worker did not take a task time of the support threshold or longer for the task item “confirmation of delivery date (A3)” belonging to the previous task step “hold customer's needs (A)”, and it is preset that the “confirmation of delivery date (A3) is a related task item of the “development of new applications (B2)” (the second row in FIG. 2C). Therefore, the outline support information 160 explaining the related task item “confirmation of delivery date (A3)” is displayed being related to the “development of new applications (B2)” of the navigation view.

### (Support Information Displaying Sequence)

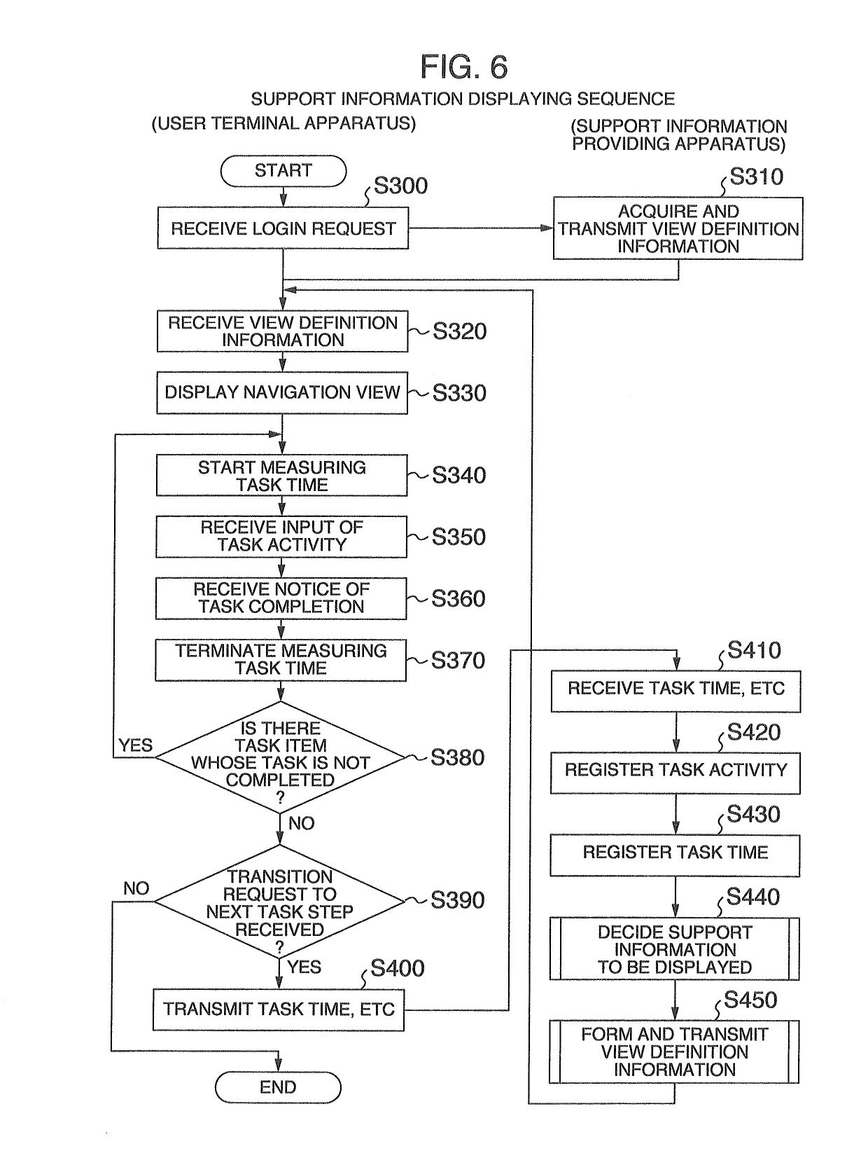

FIG. 6 is a flow chart illustrating a support information displaying sequence of the embodiment.

At Step S300 the user operation control module 36 of the worker terminal apparatus 3 receives a login request.

Specifically, the user operation control module 36 receives a login request input by a worker via the input unit 24 of the worker terminal apparatus 3, and executes a login process. If a plurality of workers are assumed, a password for each user may be received.

At Step S310, the server control module 31 of the support information providing apparatus 2 acquires and transmits view definition information.

Specifically, first the server control module 31 acquires a task step ID and view template definition (these two data sets are collectively called view definition information) in the first record of the view information definition database 45. As described earlier, records are disposed in the order of executing task steps.

Second the server control module transmits the view definition information to the worker terminal apparatus 3. The acquired task step ID is temporarily stored in the main storage unit 12. This stored task step ID is called “task step ID in navigation”.

At Step S320, the user operation control module 36 of the worker terminal apparatus 3 receives the view definition information.

At Step S330, the user operation control module 36 of the worker terminal apparatus 3 displays a navigation view.

Specifically, the user operation control module 36 displays the navigation view (FIG. 5A) on an output unit 24 of the worker terminal apparatus 3, by using the view definition information received at Step S320.

Description has been made on displaying the navigation view for the first task step (a path from Step S310). Description will be made later on displaying a navigation view for each of the second and following task steps (a path from Step S450).

At Step S340 the operation time measuring module 37 of the worker terminal apparatus 3 starts measuring a task time.

This Step is paired with Step S370 to be described later to measure a task time.

Specifically, the operation time measuring module 37 executes a process in accordance with the operation time measuring process definition in the view template definition column 142.

Namely, a lapse time from when the navigation view is displayed to when “complete” in the task status column 156 of the task item is selected is acquired as a task time of the first task item (the path from Step S330).

A lapse time from when ““complete” in the task status column 156 of the task item one item before is selected and to when “complete” in the task status column 156 of the task item is selected is acquired as a task time of each of the task items other than the first task item (the path from Step S380).

At Step S350 the user operation control module 36 of the worker terminal apparatus 3 receives task activities.

Specifically, the user operation control module 36 receives the task activities input by the worker relative to the view components displayed in the task information column 155 such as an input form 158, pulldown selection, and radio box. The received task activities are temporarily stored in the main storage unit 22, being related to the corresponding task item ID.

At Step S360 the user operation control module 36 of the worker terminal apparatus 3 receives a notice of task completion.

Specifically, the user operation control module 36 receives a selection of “complete” in the task status column 156 by the worker.

At Step S370 the task time measuring module 37 of the worker terminal apparatus 3 terminates measuring the task time. The measured task time is temporarily stored in the main storage unit 22, being related to the corresponding task item ID.

At Step S380 the user operation control module 36 of the worker terminal apparatus 3 judges whether there is a task item whose task is still not executed.

Specifically, the user operation control module 36 returns to Step S340 if there is a task item whose task is still not executed (“YES” at Step S380). In other cases (“NO” at Step S380), the support information displaying sequence is terminated.

It is assumed that it is judged whether the button “to next task step” 157 is depressed in a predetermined time.

At Step S390 the user operation control module 36 of the worker terminal apparatus 3 judges whether a transition request to the next task step is received.

Specifically, the user operation control module 36 advances to step S400 if depressing the button “to next task step” 157 by the worker is received (“YES” at Step S390). In other cases (“NO” at Step S390), the support information displaying sequence is terminated.

It is assumed that it is judged whether depressing the button “to next task step” 157 is received in a predetermined time.

It is assumed that it is judged whether the button “to next task step” 157 is depressed in a predetermined time.

At Step S400 the user operation control module 36 of the worker terminal apparatus 3 transmits the task time and the like.

Specifically, the user operation control module 36 transmits to the support information providing apparatus 2 the task activities (related to the task item ID), task time (related to the task item ID) and transition request to the next task step.

The task activities and task time once received or acquired are transmitted to the support information providing apparatus 2, if only there is a transmission request to the next task step. The reason for this is that the task time is used when the next task step provides support information.

However, even if there is no transition request to the next task step, the support information displaying sequence may be terminated after both or one of the task activities and task time is transmitted to the support information providing apparatus 2.

At Step S410 the server control module 31 of the support information providing apparatus 2 receives the task time and the like.

Specifically, the server control module 31 receives the task activities, task time and transition request to the next task step from the worker terminal apparatus 3.

At Step S420 the task activity storage module 32 of the support information providing apparatus 2 registers the task activities.

Specifically, the task activity storage module 32 first forms new empty records of the task activity management database 41.

Second, the task step ID in navigation, the task item ID related to the task activities received as Step S410, and the task activities received at Step S410 are stored in the task step ID column 101, task item ID column 102, and task activity column 103, respectively.

If data cannot be stored normally because of excessive data capacity of task activities or the like, the operation may be executed again or an error process such as an output of an error message may be performed.

At Step S430 the task time storage module 33 of the support information providing apparatus 2 registers the task time.

Specifically, the task time storage module 33 first forms new empty records of the task time management database 42.

Second, the task step ID in navigation, the task item ID related to the task time received as Step S410, and the task time received at Step S410 are stored in the task step ID column 111, task item ID column 112, and task time column 113, respectively.

If data cannot be stored normally because of excessive data capacity of task activities or the like, the operation may be executed again or an error process such as an output of an error message may be performed.

At Step S440 the support information judging module 34 of the support information providing apparatus 2 decides the support information to be displayed.

The details of Step S440 will be described later.

At Step S450 the view forming module 35 of the support information providing apparatus 2 transmits the view definition information. The details of Step S450 will be later given.

The support information displaying sequence is thus completed.

### (Support Information Judging Sequence)

The support information judging sequence is a sequence of regarding a task time as a numerical value reflecting a skill (practice) of a worker relative to a related task item, and judging which one of “detailed support information” and “outline support information” on the task item is displayed, in accordance with the work time. The support information judging sequence indicates the details of Step S440. A “narrowing” step corresponds to this support information judging sequence.

### (First Judging Method)

A ratio of a task time regarding a related task item to a task time of all task items in the task step to which the related task item belongs is compared with a predetermined threshold. A judgment result is obtained to the effect that the “detailed support information” is displayed if the task time regarding the related task item is equal to or longer (less accustomed) than the threshold, whereas in other cases (accustomed), the “outline support information” is displayed.

### (Second Judgment Method)

An order of length of a task time regarding a related task item among lengths of task times of all task items in the task step to which the related task item belongs is compared with a predetermined threshold. A judgment result is obtained to the effect that the “detailed support information is displayed if the order of the task time regarding the related task item is equal to or upper (less accustomed) than the threshold, whereas in other cases (accustomed), the “outline support information” is displayed.

For the details of Step S440, either the support information judging sequence using the first judgment method or the support information judging sequence using the second judgment method is executed as in the following.

### (Support Information Judging Sequence Using First Judging Method)

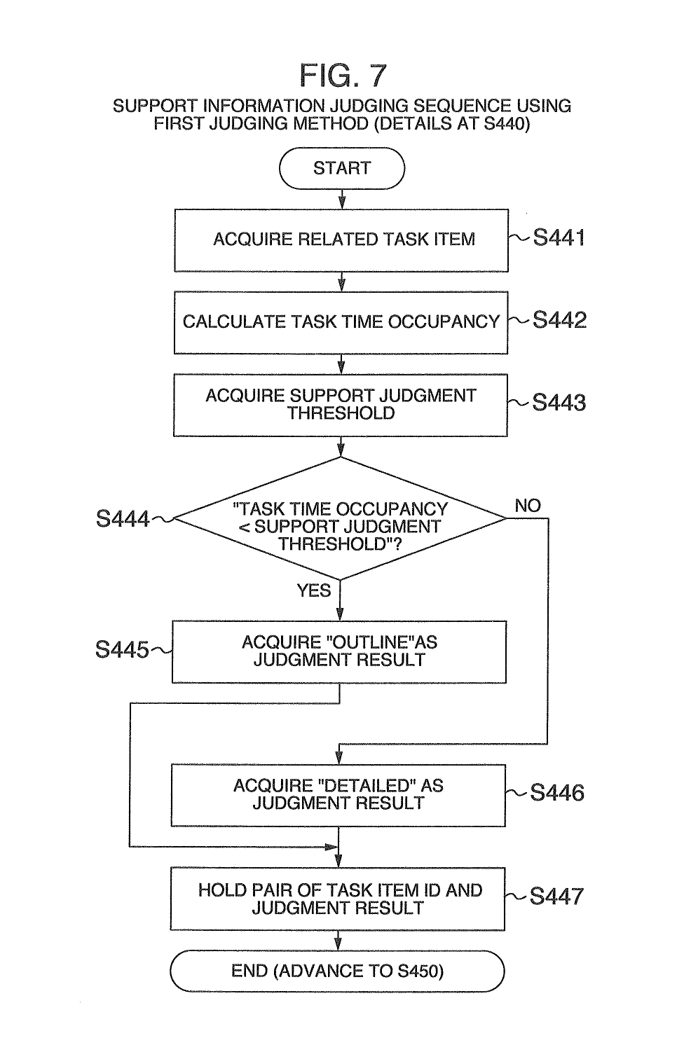

FIG. 7 is a flow chart illustrating the support information judging sequence using the first judging method.

At Step S441 the support information judging module 34 of the support information providing apparatus 2 acquires a related task item.

Specifically, the support information judging module 34 searches the related task step ID column 123 of the task item relation management table 43, by using the task step ID in navigation as a search key, and acquires corresponding records.

It is assumed in this case that the records in the first and second rows are acquired.

At Step S442 the support information judging module 34 of the support information providing apparatus 2 calculates a task time occupancy.

Specifically, “firstly” the support information judging module 34 acquires arbitrary one of the records acquired at Step S441 (it is assumed that the record in the first row is acquired).

“Secondary”, the task ID column 112 of the task time management database 42 is searched by using as a search key the related task item ID (itemA1) acquired “firstly”, and a task time of the corresponding record is acquired (“7” is acquired).

“Thirdly”, the task step ID column 111 of the task time management database 42 is searched by using as a search key the task step ID in navigation, and a total sum of task times of all corresponding records is calculated (“7+1+2=10” is calculated).

“Fourthly”, a task time occupancy is calculated by dividing the task time acquired “secondary” by the total sum calculated “thirdly” (“7/10=0.7 (70%) is calculated).

At Step S443 the support information judging module 34 of the support information providing apparatus 2 acquires the support judging threshold.

Specifically, the support information judging module 34 first searches the task item ID column 132 of the support information definition database 44, by using as a search key the task item ID of the record acquired “firstly” at Step S442, to acquire the support judgment threshold of the corresponding record (“0.3 (30%)” is acquired).

At Step S444 the support information judging module 34 of the support information providing apparatus 2 judges whether “task time occupancy<support judgment threshold”.

Specifically, the support information judging module 34 compares the task time occupancy calculated at Step S442 with the support judgment threshold acquired at Step S443, and if “task time occupancy<support judgment threshold” (“YES” at Step S444), then the flow advances to Step S445, whereas in other cases (“NO” at Step S444), the flow advances to Step S446.

At Step S445 the support information judging module 34 of the support information providing apparatus 2 acquires the “outline” as the judgment result.

At Step S446, the support information judging module 34 of the support information providing apparatus 2 acquires the “detailed” as the judgment result.

The processes at Steps S442 to S446 are repeated for all records acquired at Step S441 (for all related task items).

At Step S447 the support information judging module 34 of the support information providing apparatus 2 holds a pair of task item ID and judgment result.

At this time, the support information judging module 34 acquires one or a plurality of pairs of task item IDs and judgment results.

Specifically, the support information judging module 34 forms a pair of a task item ID of the record acquired “firstly” at Step S442 and a judgment result acquired at Step S445 (or S446), and temporarily holds the pair. For example, it is herein assumed that pairs “itemB1, detailed” and “itemB2, outline” are acquired as pairs representative of “task item ID, judgment result”.

The support information judging sequence using the first judging method is thereafter terminated to advance to Step S450.

### (Support Information Judging Sequence Using Second Judging Method)

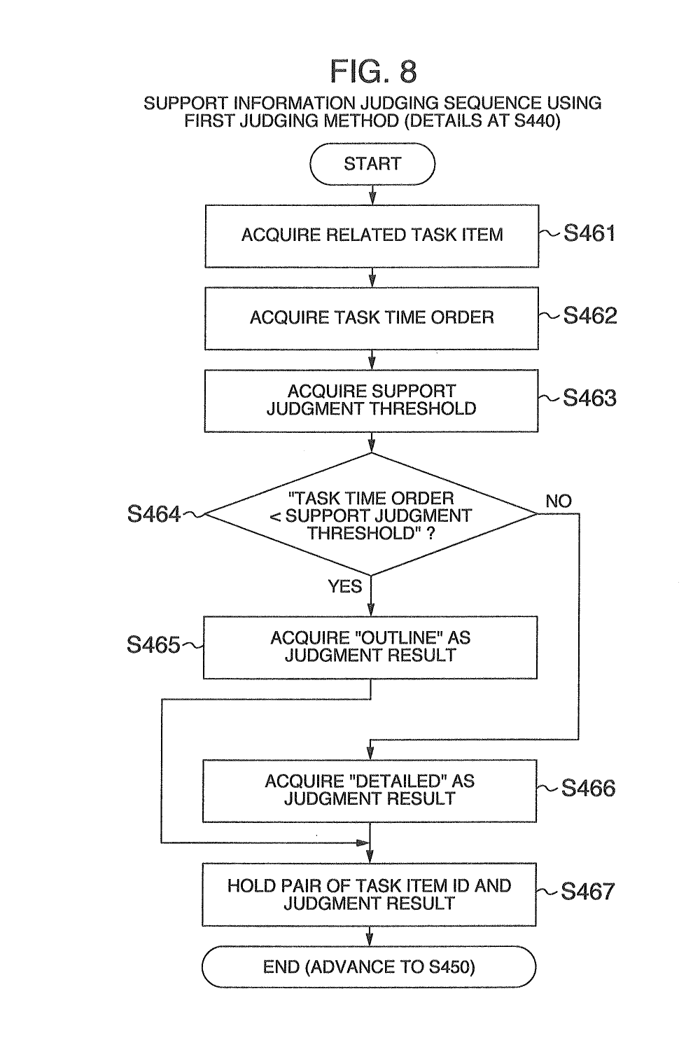

FIG. 8 is a flow chart illustrating the support information judging sequence using the second judging method.

It is assumed that the support judgment threshold column 133 of the support information definition database 44 stores an order of length of a task time of a task item belonging to the previous task step among lengths of task times of all task items belonging to the previous task step.

Step S461 is the same as Step 441.

At Step S462 the support information judging module 34 of the support information providing apparatus 2 acquires a task time order.

Specifically, “firstly” the support information judging module 34 acquires arbitrary one of the records acquired at Step S461 (it is assumed that the record in the first row is acquired).

“Secondary”, the task ID column 112 of the task time management database 42 is searched by using as a search key the related task item ID (itemA1) acquired “firstly”, and a task time of the corresponding record is acquired (“7” is acquired).

“Thirdly”, the task step ID column 111 of the task time management database 42 is searched by using as a search key the task step ID in navigation, and a total sum of task times of all corresponding records is acquired (“7”, “1” and “2” are acquired).

“Fourthly”, an order (task time order) of length of the task time acquired “secondary” among lengths of the task times acquired “thirdly” is acquired (a task order “1” is acquired).

Step S463 is the same as Step 443.

At Step S464 the support information judging module 34 of the support information providing apparatus 2 judges whether “task time order<support judgment threshold”.

Specifically, the support information judging module 34 compares the task time order acquired at Step S462 with the support judgment threshold acquired at Step S463, and if “task time order<support judgment threshold” (“YES” at Step S464), then the flow advances to Step S465, whereas in other cases (“NO” at Step S464), the flow advances to Step S466.

Steps S465 to S467 are the same as Steps 445 to S447.

### (Support Information Display Method)

The navigation view (FIG. 5B) for each of the second and following task steps changes its display contents in some cases as different from the navigation view (FIG. 5A) for the first task step. Namely, the support information to be displayed changes depending upon whether a worker took time to execute which task item among task items belonging to the previous task step.

The support information of the embodiment includes two types: outline support information and detailed support information. Three display methods will be described as variations of the display method for a navigation view.

In the first display method, if the judgment result is the “detailed”, the detailed support information is displayed being related to the task item, whereas if the judgment result is the “outline”, the outline support information is displayed being related to the task item.

In the second display method, if the judgment result is the “detailed”, the detailed support information is displayed being related to the task item, whereas if the judgment result is the “outline”, the outline support information (itself) is displayed being related to the task item, and also link information to the detailed support information is displayed. With this method, if a worker referred to the outline support information can also refer to the detailed support information, if only the worker requires the detailed support information. This method is therefore effective for the case in which, for example, although a worker can execute a task sufficiently in an ordinary state by using the outline support information, the worker forgets accidentally a work manual or the like. This method is desired for a job likely to be subjected to occurrence of accidental forgetting, such as a job with complicated task contents and a job with a low task frequency.

In the third display method, if the judgment result is the “detailed”, the detailed support information is displayed being related to the task item, whereas if the judgment result is the “outline”, the outline support information is displayed once being related to the task item, and after a lapse of a predetermined time, the detailed support information is displayed additionally. The view definition information for displaying the detailed support information may be entered in advance in the worker terminal apparatus 3, and the detailed support information is not displayed until a lapse of the predetermined time. Alternatively, after a lapse of the predetermined time, the view definition information may be fetched from the support information providing apparatus 2 into the worker terminal apparatus 3. As compared with the second display method, it is possible to omit a worker operation of calling the detailed support information by using the input unit 24 such as a mouth or the like. However, a worker operation of setting the lapse time is additionally required so as to match the timing when the worker becomes necessary for the detailed support information.

### (View Forming Sequence)

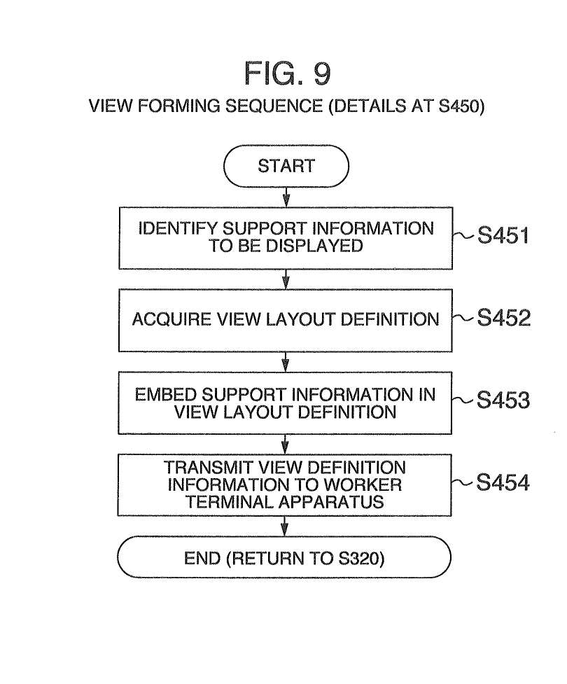

FIG. 9 is a flow chart illustrating a view forming sequence of the embodiment.

The view forming sequence is a sequence of forming the view template definition for displaying the navigation view of each of the second and following task steps, and illustrates the details of Step S450. The view forming sequence will be described assuming that the second display method described above is incorporated.

At Step S451 the view forming module 35 of the support information providing apparatus 2 identifies the support information to be displayed.

Specifically, the view forming module 35 acquires “firstly” arbitrary one (e.g., itemB1, detailed) of pairs acquired at Step S447 (or Step 467).

“Secondary”, the support information database 44 is searched by using as a search key the task item ID contained in the pair acquired “firstly” to acquire a corresponding record.

“Thirdly”, if the judgment result contained in the pair acquired “firstly” is the “detailed”, the detailed support information in the record acquired “secondary” is acquired, whereas if the judgment result contained in the pair acquired “firstly” is the “outline”, the outline support information and detailed support information in the record acquired “secondary” is acquired. In this example, the outline support information “◯◯◯” and detailed support information “◯◯-◯◯-◯◯”, or only the detailed support information “◯◯-◯◯-◯◯” is acquired.

At Step S452 the view forming module 35 of the support information providing apparatus 2 acquires the view layout definition.

Specifically, the view forming module 35 acquires first a record next to the record containing the task step ID in navigation, from records of the view information definition database 45.

Second, the view layout definition is acquired from the view template definition in the record acquired “firstly”.

At Step S453 the view forming module 35 of the support information providing apparatus 2 embeds the support information in the view layout definition.

Specifically, the view forming module 35 adds a command statement of the view layout so as to display the support information acquired “thirdly” at Step S451 being related to the task item identified by the task item ID contained in the pair acquired “firstly” at Step S451.

In this example, a command statement “display “◯◯-◯◯-◯◯” for the task item itemB1” is formed and embedded in the view layout definition.

If the pair acquired “firstly at Step S451 is (itemB2, outline), a command statement “display “ΔΔΔ” for the task itemB2 and link information of “ΔΔ-ΔΔ-ΔΔ” is formed and embedded in the view layout definition. “ΔΔ-ΔΔ-ΔΔ” is not displayed when necessary until the worker refers to.

Steps S451 to S453 are repeated for all pairs acquired at Step S447 (or S467).

At Step S454 the view forming module 35 of the support information providing apparatus 2 transmits the view definition information to the worker terminal apparatus 3.

In this case, the view forming module 35 refers to the view information definition database 45, and acquires the task step ID next to the task step ID in navigation. The acquired task step ID is held as the task step ID in new navigation, instead of the task step ID in previous navigation.

The view forming sequence has been completed, and the flow returns to Step S320.

### (Supplementary Description of Step S330)

As described previously, at Step S330 the user operation control module 36 of the worker terminal apparatus 3 displays a navigation view. As the flow advances to Step S330 via Step S450, the navigation view (FIG. 5B) is displayed on the output unit 24 of the worker terminal apparatus 3, by utilizing the view definition information embedded in the support information. In FIG. 5B, the support information is displayed being related to the task item. In this example, character information is displayed in the view as the support information. However, either video information may be displayed, or audio information may by output from the output unit 25 such as a speaker. Instead of these display and output or with a combination thereof, the support information may be output to an external storage unit, being related to the task item.

It should be further understood by those skilled in the art that although the foregoing description has been made on embodiments of the invention, the invention is not limited thereto and various changes and modifications may be made without departing from the spirit of the invention and the scope of the appended claims.

1. A support information providing apparatus for providing each of a plurality of task items belonging to each of a plurality of ordered task steps with support information for supporting execution of each of said task items, which comprises a control unit, wherein:
said control unit narrows, when one task item belonging to one task step is to be executed, a plurality of support information candidates down to one support information candidate related to said one task item to be executed, in accordance with a task status of a task item by a worker belonging to a task step ordered before said one task step, and provides said narrowed-down support information candidate being related to said task item to be executed.

2. A support information providing apparatus for providing each of a plurality of task items belonging to each of a plurality of ordered task steps with support information for supporting execution of each of said task items, which comprises a storage unit and a control unit, wherein:
said storage unit comprises:
a task item relation management database for storing in a mutually related state a first identifier for identifying a task item belonging to a current task step as a task step at an arbitrary timing, and a second identifier for identifying a related task item as a task item related to the task item belonging to said current task step, among task items belonging to a previous task step as a task step ordered before said current task step; and
a task status management database for storing in a mutually related state said second identifier and a task status of said related task item by a worker; and
said control unit acquires said second identifier stored in said task item relation management database for each first identifier, and searches said task status management database by using as a search key said acquired second identifier to acquire the task status of said related task item by the worker, and narrows a plurality of support information candidates down to one support information candidate in accordance with said acquired task status, and provides said narrowed-down support information candidate to each task item belonging to said current task step.

3. The support information providing apparatus according to claim 2, wherein said task status is a task time of said related task item taken by the worker.

4. The support information providing apparatus according to claim 2, wherein said task status is task activities of said related task item acquired from the worker.

5. The support information providing apparatus according to claim 3, wherein said control unit narrows said plurality of support information candidates down to said one support information candidate, in accordance with a ratio of a task time of said related task item taken by the worker to a total sum of task times of task items belonging to said previous task step.

6. The support information providing apparatus according to claim 3, wherein said control unit narrows said plurality of support information candidates down to said one support information candidate, in accordance with an order of a length of a task time of said related task item taken by the worker, among lengths of task times of task items belonging to said previous task step.

7. The support information providing apparatus according to claim 1, wherein said plurality of support information candidates are classified at a granularity of multi stages, and said control unit narrows said support information candidates classified at the granularity of multi stages down to any one of said support information candidates, and provides said narrowed-down support information candidate.

8. The support information providing apparatus according to claim 7, wherein said control unit provides support information other than said narrowed-down support information candidate, upon request from the worker.

9. The support information providing apparatus according to claim 7, wherein said control unit provides support information other than said narrowed-down support information candidate, upon lapse of a predetermined time.

10. A support information providing method for a support information providing apparatus for providing each of a plurality of task items belonging to each of a plurality of ordered task steps with support information for supporting execution of each of said task items, which comprises a control unit, wherein:
said control unit narrows, when one task item belonging to one task step is to be executed, a plurality of support information candidates down to one support information candidate related to said one task item to be executed, in accordance with a task status of a task item by a worker belonging to a task step ordered before said one task step, and provides said narrowed-down support information candidate being related to said task item to be executed.

11. A support information providing method for a support information providing apparatus for providing each of a plurality of task items belonging to each of a plurality of ordered task steps with support information for supporting execution of each of said task items, which comprises a storage unit and a control unit, wherein:
said storage unit comprises:
a task item relation management database for storing in a mutually related state a first identifier for identifying a task item belonging to a current task step as a task step at an arbitrary timing, and a second identifier for identifying a related task item as a task item related to the task item belonging to said current task step, among task items belonging to a previous task step as a task step ordered before said current task step; and
a task status management database for storing in a mutually related state said second identifier and a task status of said related task item by a worker; and
said control unit executes the steps of:
acquiring said second identifier stored in said task item relation management database, for each first identifier;
searching said task status management database by using as a search key said acquired second identifier to acquire the task status of said related task item by the worker;
narrowing a plurality of support information candidates down to one support information candidate in accordance with said acquired task status; and
providing said narrowed-down support information candidate to each task item belonging to said current task step.

12. The support information providing method according to claim 11, wherein said task status is a task time of said related task item taken by the worker.

13. The support information providing method according to claim 11, wherein said task status is task activities of said related task item acquired from the worker.

14. The support information providing method according to claim 12, wherein said control unit narrows said plurality of support information candidates down to said one support information candidate, in accordance with a ratio of a task time of said related task item taken by the worker to a total sum of task times of task items belonging to said previous task step.

15. The support information providing method according to claim 12, wherein said control unit narrows said plurality of support information candidates down to said one support information candidate, in accordance with an order of a length of a task time of said related task item taken by the worker, among lengths of task times of task items belonging to said previous task step.

16. The support information providing method according to claim 10, wherein said plurality of support information candidates are classified at a granularity of multi stages, and said control unit narrows said support information candidates classified at the granularity of multi stages down to any one of said support information candidates, and provides said narrowed-down support information candidate.

17. The support information providing method according to claim 16, wherein said control unit provides support information other than said narrowed-down support information candidate, upon request from the worker.

18. The support information providing method according to claim 16, wherein said control unit provides support information other than said narrowed-down support information candidate, upon lapse of a predetermined time.

19. A support information providing program for operating a support information providing apparatus for providing each of a plurality of task items belonging to each of a plurality of ordered task steps with support information for supporting execution of each of said task items, wherein said support information providing apparatus comprises a control unit, wherein
said control unit is made to execute steps of:
narrowing, when one task item belonging to one task step is to be executed, a plurality of support information candidates down to one support information candidate related to said one task item to be executed, in accordance with a task status of a task item by a worker belonging to a task step ordered before said one task step; and
providing said narrowed-down support information candidate being related to said task item to be executed.

20. A support information providing program for operating a support information providing apparatus for providing each of a plurality of task items belonging to each of a plurality of ordered task steps with support information for supporting execution of each of said task items, by using:
a task item relation management database for storing in a mutually related state a first identifier for identifying a task item belonging to a current task step as a task step at an arbitrary timing, and a second identifier for identifying a related task item as a task item related to the task item belonging to said current task step, among task items belonging to a previous task step as a task step ordered before said current task step; and
a task status management database for storing in a mutually related state said second identifier and a task status of said related task item by a worker, wherein said support information providing apparatus comprises a control unit, wherein
a control unit is made to execute steps of:
acquiring said second identifier stored in said task item relation management database, for each first identifier;
searching said task status management database by using as a search key said acquired second identifier to acquire the task status of said related task item by the worker;
narrowing a plurality of support information candidates down to one support information candidate in accordance with said acquired task status; and
providing said narrowed-down support information candidate to each task item belonging to said current task step.
